(19) United States
(12) Patent Application Publication
(10) Pub. No.: US 2006/0286436 A1
(43) Pub. Date: Dec. 21, 2006

(54) Planar fuel cell stack and method of fabrication of the same

(76) Inventors: Amir Faghri, Farmington, CT (US); Zhen Guo, Farmington, CT (US)

Correspondence Address: EDWARDS & ANGELL, LLP, P.O. BOX 55874, BOSTON, MA, 02205, US

(21) Appl. No.: 11/157,645

(22) Filed: Jun. 21, 2005

(51) Int. Cl. H01M 4/86; H01M 4/88

(52) U.S. Cl. 429/44; 29/623.3; 502/101

(57) ABSTRACT

The present invention provides a system and method for forming an air breathing fuel cell that includes an air permeable cathode layer positioned to be in contact with atmospheric air and an electrically conductive, fuel permeable anode backing layer positioned to be in contact with a mixture of fuel and water, wherein the anode and cathode layers are divided by a pre-swollen electrolyte membrane, and the anode and cathode layers are in contact with electrical current collecting members. The present invention also provides a fuel cell stack consisting of fuel cells of the present invention arranged in a grid-like format within a support frame that is configured to provide electrical connections between the fuel cells.

### BACKGROUND OF THE INVENTION

1. Field of the Invention

The present invention relates to electrochemical fuel cells, and in particular, an air breathing fuel cell and fuel cell stack along with methods for forming the same.

2. Brief Description of the Related Art

A fuel cell is an electrochemical energy conversion device that transfers the chemical energy in the fuel directly into electric energy. Unlike conventional power devices such as gas turbines, steam turbines and internal combustion engines based on certain thermal cycles, the maximum efficiency of fuel cells is not limited by the Carnot cycle principle.

In a fuel cell electrons are released from the oxidation of fuel at the anode, protons (or ions) pass through an electrolyte, and the electrons are required for reduction of an oxidant at the cathode. The desired output is the largest flow of electrons over the highest electrical potential. Although other oxidants are theoretically possible, oxygen is the standard because of its availability in the atmosphere. Typical fuels used are hydrogen, carbon monoxide or a hydrocarbon fuel (i.e., methane, methanol). Hydrogen and carbon monoxide may be the products of catalytically processed

A conventional proton exchange membrane fuel cell (PEMFC) can be subdivided into five parts: a membrane electrode assembly (MEA), gas diffusion layers (GDLs), flow channel plates, end plates and manifold structures at both fuel and air sides. The MEA is typically the key component of a PEMFC. The MEA is composed of a proton exchange membrane sandwiched between two electrodes: the anode, where fuel is oxidized, and the cathode, where oxygen from air is reduced. The GDL is formed from a porous material, which must have relatively high electrical conductivity, high gas permeability and good water management characteristics.

In practice, fuel cells are generally not operated as single units, but are connected in a series to additively combine the individual cell potentials and achieve a greater, and more useful, potential. Such a collection of fuel cells in series is known as a “stack”. For conventional actively driven fuel cells, the most popular way of interconnection is to use a bipolar plate. The cathode of a first cell is connected with the anode of the next cell, while the bipolar plate serves as a means of feeding oxygen to the cathode and fuel to the anode. The fuel cell stack consists of repeated interleaved structure of MEAs, GDLs and bipolar plates. All these components are clamped together with significant force to reduce electrical contact resistance. The fuel and oxidant are provided with manifolds to the correct electrodes, and cooling is provided either by the reactants or by a cooling medium.

Typically, the aforementioned type of fuel cell works with forced airflow on the cathode side and forced fuel flow on the anode side, requiring various auxiliary components and a rather complicated control system. Such a fuel cell does not fit the requirements for low power battery replacement applications. For these applications, the key challenges are to provide acceptable power output and high-energy efficiency in convenient conditions to the user. The typical desired operating conditions are, for example, an operating temperature near room temperature, with no forced air flow or recirculation fuel pump. It is well known that a forced air design with an external blower is not an attractive option for small fuel cell systems, as the parasitic power losses from the blower are estimated at 20-25% of the total power output. Thus, passive air breathing designs are typically used in most small fuel cell designs.

The unique requirements of air-breathing for the small fuel cells have led to several different designs. U.S. Pat. No. 6,596,422, which is hereby incorporated herein by reference, provides an air breathing direct methanol fuel cell (DMFC) structure. In this design, perforated metal sheets were used to replace flow channel plates for current collecting purposes, and holes were made in positive and negative end plates to permit natural diffusion of air to the cathode and fuel to the anode. Similar positive and negative end plates are also used in U.S. Pat. No. 6,689,502, which is hereby incorporated herein by reference. To supply fuel and oxygen continuously to the cell, the fuel and oxygen must penetrate through these holes in the negative and positive end plates, respectively. The byproduct, such as CO₂ at the anode in DMFCs, exits the cell through these holes at the negative end plates. The open area ratio (total area of holes to total area of the end plate) is about 40-60% for these end plates. As a result, the area available for the diffusion of fluids (fuel, oxygen and byproducts) is reduced accordingly and diffusion path length is increased due to the thickness of the end plate. This limits mass transfer and also lowers the cell power density (mW/cm²), among other things.

Single cells described in the preceding paragraph can be electrically connected together to form a fuel cell stack, such as a planar fuel cell stack. In the aforementioned U.S. Pat. No. 6,689,502, a planar fuel cell stack is disclosed that uses common current collectors to connect the anodes and cathodes of adjacent single cells. The primary drawback of this design is that the stack and associated hardware are too heavy for many small applications, such as for portable applications and personal use, since all components are clamped together with significant force (as is done in conventional actively driven fuel cells) to reduce electrical contact resistance. The end plates are thus usually designed to be very heavy to sustain this force.

Accordingly, there is a need for a lightweight fuel cell stack that provides an improved power density (mW/cm²) in convenient conditions to the user and eliminates the need for ancillary equipment.

Furthermore, there is a need for a fuel cell stack with an anode structure for efficient fuel delivery, provides the largest possible area exposed to air for efficient air-breathing operation, provides low electrical contact resistance without associated heavy hardware, is capable of being used in modules that could be fabricated separately from the ancillary system, and is capable of being used in modules that could be configured together to meet the power requirements of specific applications.

### SUMMARY OF THE DISCLOSURE

The present invention improves upon and solves the problems associated with the prior art by providing, among other things, a system and method that addresses the above identified needs.

The present invention is directed to an air breathing fuel cell that includes an air permeable cathode layer positioned to be in contact with atmospheric air and an electrically conductive, fuel permeable anode backing layer positioned to be in contact with a mixture of fuel and water, wherein the anode and cathode layers are divided by a pre-swollen electrolyte membrane, that is, an electrolyte membrane having undergone a pre-swelling process, and the anode and cathode layers are in contact with electrical current collecting members.

In one embodiment of the fuel cell of the present invention, the current collecting member is in the form of an electrically conductive mesh. The mesh can be configured and dimensioned so that the percentage of total open area along its surface ranges from about 10% to about 80% of the total surface area. Preferably, the mesh is fabricated of a substantially non-corrosive material. The mesh may also be formed of a composite including a non-corrosive substantially rigid substrate and electrically conductive layer. Preferably, the mesh is formed of a substantially copper core, a layer of substantially niobium disposed on the copper core and an outer layer substantially of platinum disposed on the substantially niobium layer.

In another embodiment, the fuel cell of the present invention can include a membrane that is shaped generally rectangular, in that it defines a longitudinal x-axis, latitudinal y-axis and depth defined by a z-axis. The membrane may be formed by a pre-swelling method of the present invention which includes the steps of exposing the membrane to an aqueous methanol solution, securing the longitudinal and latitudinal edges of the membrane to prevent longitudinal and latitudinal shrinking while permitting the membrane to shrink along the z-axis, and drying the secured membrane. The membrane may be allowed to air dry and thereafter reduced into portions commensurate with size and shape of the single cell.

In another embodiment, the fuel cell of the present invention can include an anode backing layer that is formed of a material which has been treated to impart hydrophilic characteristics thereon. In accordance with the present invention, the method of imparting the hydrophilic characteristics can include dissolving tin tetrachloride pentahydrate (SnCl₄.5H₂O) in water to yield a concentration of tin tetrachloride of about 1.7 moles per liter, pouring the tetrachloride solution into a vial to sufficient depth to amply submerge carbon fiber media placed therein, placing the vial into a ultrasonic bath and apply ultrasonic treatment for about 10 minutes, removing the carbon fiber medium from the tin tetrachloride solution in an aqueous solution of ammonia of concentration sufficient to achieve a pH of about 9, maintaining the pH of the bulk of the solution in the range of about 5 to about 9 for a period of about 6 hours, removing the carbon fiber paper from the ammonia solution, and calcining the fiber paper in air at a temperature of about 400° C. for about one hour. The method can include repeating the aforementioned steps to improve the carbon fiber medium wettability.

The fuel cell of the present invention can be formed by being hot pressed along with thermo-bond film. The present invention is also directed to a fuel cell stack, wherein a plurality of fuel cells constructed in accordance with the present invention are arranged in a grid-like planar formation within an support frame including electrically conductive portions for electrically connecting the plurality of the fuel cells. The support frame is configured to provide electrical connections with the current collecting members disposed in the individual fuel cells.

The present invention is also directed to a method of forming a planar fuel cell stack that includes pre-swelling an electrolyte membrane having a first and a second surface, treating an electrically conductive anode backing layer having a first and a second surface to impart hydrophilic characteristics thereto, providing an electrically conductive cathode backing layer having a first and a second surface, disposing the first surface of the electrically conductive anode backing layer on the first surface of the electrolyte membrane and the second surface of the electrically conductive cathode backing layer on the second surface of the electrolyte membrane, disposing a first current collecting member on the first surface of the cathode backing layer and a second current collecting member on the second surface of the anode backing layer, and securing the entire configuration in position.

The method can further include securing a plurality of fuel cells in a grid-like pattern on a support frame configured to provide electrical connections between the plurality of fuel cells.

In sum, the present invention is directed to a novel stack design, which, as described herein, entails an air breathing fuel cell having a membrane electrode assembly, a cathode assembly permeable to air and directly open to atmospheric air, and a conductive assembly permeable to fuel and in direct contact with a mixture of fuel and water. The design of the present invention also provides a larger possible open area for air and fuel supply regions.

Preferably, such cells may be assembled into a stack by constructing them in a window frame arrangement such that several cells are located in one planar layer, with the planar fuel cell internally connecting the cells.

To reduce the internal contact resistance of the cell, the GDLs are hot-pressed to the membrane electrode assembly. The edges of the GDL and current collector are dipped into a Nafion® solution to reduce delamination.

Nafion® a commercially available perfluorinated sulfonic acid ionomer manufactured by E.I. du Pont de Nemours & Co. Nafion® is a copolymer of tetrafluoroethyelene and sulfonyl fluoride vinyl ether and has reverse micelle morphology in the dry state, where the ionic clusters are dispersed in a continuous tetrafluoroethyelene phase. The Teflon-like inert hydrophobic backbone provides chemical, mechanical and thermal stability, whereas the pendant sulfonic acid group of the vinyl ether imparts hydrophilicity and, most importantly, proton conductivity.

The electrolyte membrane is pre-swollen to reduce membrane swelling during fuel cell operation. The pores in the anode backing layer are partially filled with metal oxide granules, which impact increased mass transfer of dilute methanol solution to the cell.

The present invention include provides a planar fuel cell stack structure that facilitates the diffusion of fluids (reactants and byproducts) into and out of the cell, a window-frame structure design that provides a larger open area at the cathode and anode sides for more efficient mass transfer, a stack having a module design nature making it possible to fabricate the stack separately from other components of the fuel cell system and in which modules can be configured together to meet the power requirements of specific applications. Also, the MEA and GDLs are laminated together to reduce electrical contact resistance, which eliminates the associated heavy hardware. The pre-swelling of the electrolyte membrane can prevent the formation of membrane wrinkles and delamination of MEA and GDLs. Hydrophilic treatment of the anode backing layer improves the mass transfer limitation of dilute methanol solution at the anode side. The composite current collector is low cost, high electrical conductive and higher corrosion resistant. Thermal-bond film is used to eliminate the screw clamping, which results in a uniform distribution of clamping force as well as a lightweight fuel cell stack.

These and other aspects of the present invention will become more readily apparent to those having ordinary skill in the art from the following description of the invention taken in conjunction with the drawings.

### BRIEF DESCRIPTION OF THE FIGURES

So that those having ordinary skill in the art to which the present invention pertains will more readily understand how to make and use the present invention, an embodiment thereof will be described in detail with reference to the drawings, wherein:

FIG. 1 is a top view of a single cell constructed in accordance with the present invention for use in a planar fuel cell stack of the present invention;

FIG. 2 is an exploded schematic diagram of the single cell of FIG. 1;

FIG. 3 is a schematic diagram of a planar fuel cell stack constructed in accordance with the present invention and employing multiple single cells of FIG. 1;

FIG. 4 is a perspective view of a proton exchange membrane for use in the single cell of FIG. 1;

FIG. 5A is a perspective view of a composite backing layer constructed in accordance with the present invention for use in the single cell of FIG. 1, including a Nafion® suspension disposed at the edges thereof;

FIG. 5B is a perspective view of a metal mesh current collector constructed in accordance with the present invention for use in the single cell of FIG. 1, including a Nafion® suspension disposed at the edges thereof;

FIG. 6A is a schematic diagram of a seven-layer membrane electrode assembly for use in the single cell of FIG. 1, having enhanced bonding at its edges and illustrating the hot-press process and the Teflon substitutes placed thereon;

FIG. 6B is a schematic diagram of the seven-layer membrane electrode assembly of FIG. 6A after a cooling down period and the Teflon substitutes have been removed;

FIG. 7A is a schematic diagram of a planar fuel cell stack of the present invention having four single fuel cells in electrical communication via a common current collector sheet;

FIG. 7B is a cross sectional view of the planar fuel cell stack of FIG. 7A taken along line 7B-7B;

FIG. 7C is an enlarged view of the portion of planar fuel cell stack encircled in FIG. 7B, illustrating the interconnection between adjacent cells;

FIG. 8 is a schematic diagram of the four single cell support structure portion of the planar fuel cell stack shown in FIGS. 7A-7C;

FIG. 9A is another exemplary embodiment of a planar fuel cell stack constructed in accordance with the present invention and including four single fuel cells in electrical communication via a common current collector sheet disposed in the support structure;

FIG. 9B is a cross sectional view of the planar fuel cell stack of FIG. 9A taken along line 9B-9B; and

FIG. 10 is a schematic diagram of the four single cell support structure portion of the planar fuel cell stack illustrating the three ribs for reinforcement purposes shown in FIGS. 9A-9B.

### DETAILED DESCRIPTION OF THE INVENTION

It is to be understood that the system and method of the present invention may be advantageously employed without the incorporation of each of the features disclosed herein. It is to be further understood that modifications and variations may be utilized without departure from the spirit and scope of this inventive system and method, as those skilled in the art will readily understand. Such modifications and variations are considered to be within the purview and scope of the appended claims and their equivalents.

Single Cell Fabrication

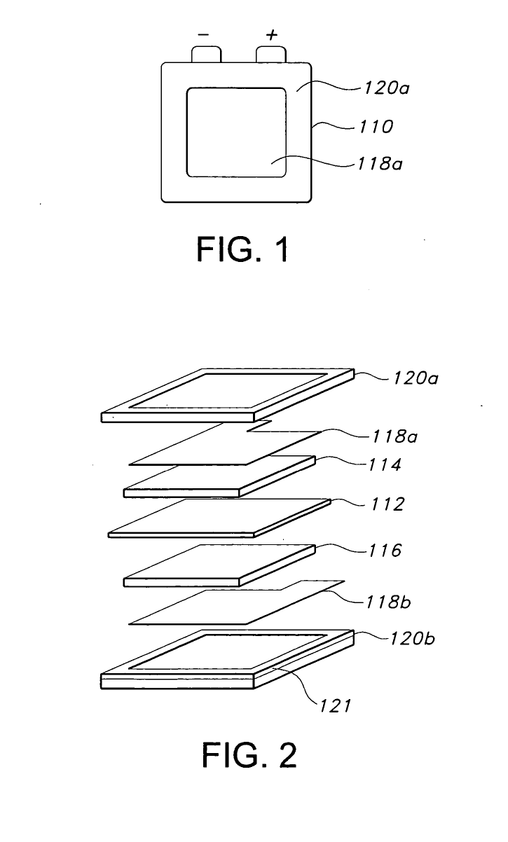

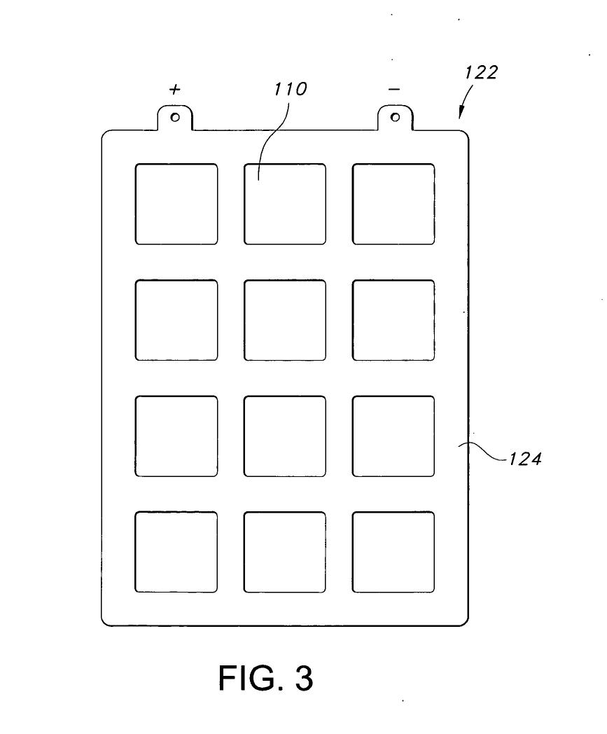

As shown in FIGS. 1 and 2, a single cell 110 constructed in accordance with the present invention includes a membrane 112 disposed in between an anode 114 and a cathode 116. The opposing side of anode 114 is adjacent a metal mesh current collector 118a and the opposing side of cathode 116 is adjacent a metal mesh current collector 118b. Preferably, anode 114 and cathode 116 comprise catalyst and/or backing layers and GDLs, which is discussed in further detail herein below. The opposing sides of metal mesh current collectors 118a and 118b are adjacent outer frames 120a and 120b, respectively, which are secured by an adhesive layer 121.

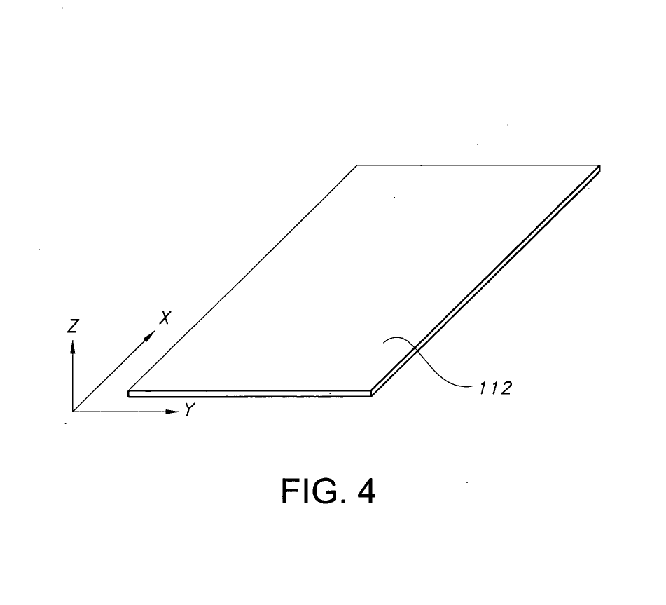

Single cell 110 can be part of a larger air breathing fuel cell, such as the inventive planar fuel cell stack 122 shown in FIG. 3, which is formed of multiple single cells 110. The multiple cells 110 are secured in a fuel cell support structure 124 which is configured to receive cells 110, receive the electrical output from each individual cell 110 and combine the same to provide a cumulative electrical output which is essentially the sum of each individual cell 110 disposed in support structure 124. In this embodiment, fuel cell support structure 124 is configured and dimensioned to receive twelve cells 110 in a grid like arrangement in the same plane. It should be readily apparent to those skilled in the art that the fuel cell support structure of the present invention is not limited by the number of cells it may house or arrangement of the cells therein.

Current collectors 118a,b may be one or more sheets of expanded metal mesh or wire mesh, although an expanded metal mesh is preferred. Ideally the expanded metal mesh or other electrically conductive material has a large portion of open area associated therewith, which can facilitate fluid flow in each single cell 110 and decrease the total weight of fuel cell 122, among other things.

The fabrication procedure of single cell 110 primarily comprises the steps of: pre-swelling an electrolyte membrane; hydrophilic treatment of the anode backing layer; selection of current collector; hot-pressing membrane/electrodes; and assembling the layers included in cell 110. These steps are described in further detail herein below.

Pre-Swelling the Membrane

Nafion® very readily absorbs water, from either gas or liquid phase. Each sulfuric acid group will absorb up to 13 molecules of water. The sulfuric acid groups form ionic channels through the bulk hydrophobic polymer, and water is very readily transported through these channels. As Nafion®® absorbs water, it will swell (increase in size) by up to 22%. When exposed to alcohols it will swell up to 88% (the hydrated membrane swells to 188% of the dry membrane).

As shown in FIG. 2, membrane 112 for single cell 110 is fixed in frames 120a,b. When operating fuel cell 110, membrane 112 will be hydrated by the dilute methanol aqueous solution and swell. Because membrane 112 is constrained by frames 120a,b, it will distort and form wrinkles in the central area. The wrinkles cause delamination of the anode and cathode 114 and 116, respectively, and increase the electrical contact resistance between anode and cathode 114 and 116 and the respective adjacent current collectors 118a,b. As a result, performance of fuel cell 122 will decline dramatically.

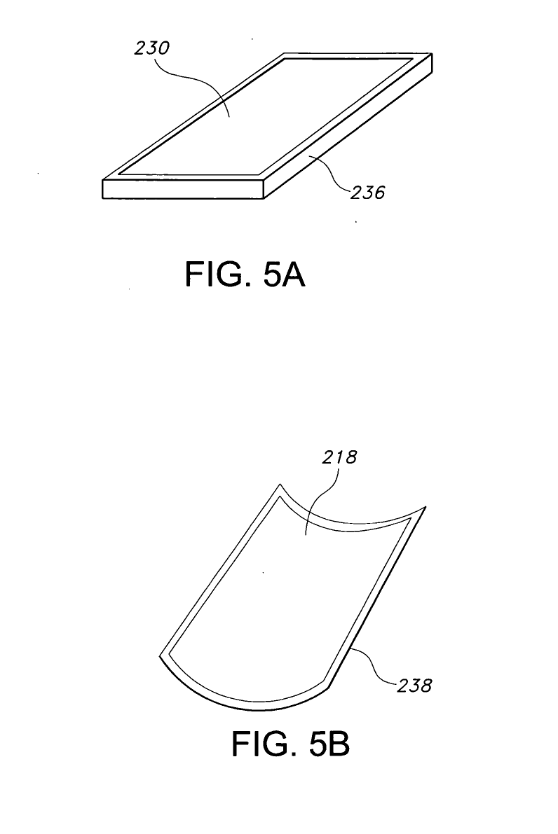

As shown in FIG. 4, the length of a membrane 112 in the x and y directions in the principal plane are much larger than in the z direction normal to the principal plane (i.e., through the thickness of the membrane). To prevent membrane 112 from swelling in the x and y directions during fuel cell operation, pre-swelling of membrane 112 in the x and y directions can be applied before assembling single cell 110. In this embodiment, the process includes the steps of immersing the membrane which will become membrane 112 with methanol aqueous solution (e.g., a 10M methanol solution), grasping the edges of the pre-swollen membrane along the x and y directions prohibiting the membrane from shrinking in these directions while permitting the membrane to shrink in the z direction during air drying, cutting the membrane strip into pieces commensurate with size and shape of the desired single cell 110.

Membrane 112 pieces may be hydrated with hot water or steam before they are assembled into a fuel cell, but they preferably will be assembled into a fuel cell while dry and subsequently hydrated in the fuel cell after assembling, but before the fuel cell is operated to produce current.

In the presently preferred assembly technique, the membrane 112 pieces swell in the z direction in situ within the cell, after assembly, which promotes reduced contact resistance between membrane 112 and the contiguous components (i.e., anode or cathode components, such as carbon fiber paper, cloth, and metal mesh) that serve to collect current.

Hydrophilic Treatment of the Anode Backing Layer

The anode of a DMFC is different from that of a H₂ operating PEMFC. For example, the anode of a DMFC must be hydrophilic to facilitate the mass transfer of dilute methanol solution. Several commercial gas diffusion layer products are available for DMFC operation. Most of them are hydrophobic, thus hydrophilic treatment is needed for improving the wettability and water absorption capacity of the anode backing layer.

The present invention includes an improved hydrophilic treatment method, which in particular, is an improvement over methods such as the method disclosed in U.S. Pat. No. 5,840,414, which is hereby incorporated herein by reference. The method of the present invention includes:

1) Dissolving tin tetrachloride pentahydrate (SnCl₄.5H₂O) in water to yield a concentration of tin tetrachloride of about 1.7 moles per liter;

2) Pouring the tetrachloride solution into a vial to sufficient depth to amply submerge carbon fiber media placed therein;

3) Placing the vial into a ultrasonic bath and apply ultrasonic treatment for about 10 minutes;

4) Remove the carbon fiber medium from the tin tetrachloride solution in an aqueous solution of ammonia of concentration sufficient to achieve a pH of about 9;

5) During a period of six hours the ammonia is neutralized by chloride ions released by hydrolysis of the tin chloride in the carbon fiber paper, while the pH of the bulk of the solution is maintained in the range of about 5 to about 9 by timely addition of fresh ammonia. In this way the tin chloride in the pores of the carbon fiber paper will be converted to an insoluble tin hydroxide.

6) After the six-hour immersion, the carbon fiber paper is removed from the ammonia solution and calcined in air at a temperature of about 400° C. for about one hour.

7) The process from 1 to 6 could be repeated several times to improve the carbon fiber medium wettability.

The chemical reactions taking place in these processes can be summarized as follows:
SnC₄+4NH₄OH→Sn(OH)₄↓+4NH₄Cl (in ammonia solution)
Sn(OH)₄→SnO₂+2H₂O (at 400° C. in oven)

Advantages of this treatment method in accordance with the present invention include stability and durability. For example, stannic hydroxide has solubility in water of pH 7 below about 10⁻⁸ moles per liter. Tin oxide (SnO₂) also has a very low solubility in water. Tin oxide will therefore be much more suitable for hydrophilic treatment of a fine pore carbon medium than silica does. In addition, although the plain carbon fiber medium can be wetted by water after ultrasonic cleaning, the treated porous carbon medium usually loses its hydrophilic property if it was exposed to air for several days. After the pores in the anode backing layers are partially filled with tin oxide, the wettability and water absorption capacity of the carbon body increases. This treatment effect is permanent.

Another hydrophilic treatment method which can be used in accordance with the present invention is disclosed in U.S. Pat. No. 6,733,841, which is hereby incorporated herein by reference. The advantage of this method is that it is simple and speedy, typically taking approximately 15 minutes. The method of treating the anode backing layer to impart hydrophilic qualities thereto includes the following steps:

1) Immersing the carbon porous medium in an aqueous dispersion of one or more metal oxides, comprising: i) 1-15% by weight metal oxide; ii) 0.01%-5% by weight dispersant;

2) Subsequently heating the carbon porous medium sufficiently to remove substantially all of the dispersant.

A Nyacol® SN15ES SnO₂ dispersion (Nyacol Nano Technologies, Inc., Ashland, Mass.) was used for all SnO₂ dispersions. The dispersion contains 15 weight % SnO₂ as received. SnO₂ particle size is 10-15 μm. Lower SnO₂ content dispersions were made by the addition of deionized water. After dilution, a trace amount of non-ionic surfactant was added to SnO₂ dispersion. The non-ionic surfactant was Triton® X100.

Selection of Current Collector

The current collectors have several functions in a passive DMFC stack. Their required properties generally follow from their functions. For example, they connect cells electrically in series, and therefore, they must be electrically conductive. They also provide the liquid and gas diffusion paths to cells, and therefore, they must be permeable to liquids and gases. Moreover, they provide structural support for the cell, and therefore, they must have adequate strength while being relatively lightweight.

Some of the above requirements may contradict each other; therefore selection of the material involves an optimization process. In addition, they must be corrosion resistant in the fuel cell environment, yet they must not be made out of expensive material. The resulting material may not be the best in any of the property categories but is the one that best satisfies the optimization criteria, which typically depends on the best performance of the fuel cell and availability.

Since the planar fuel cell stack design of the present invention has no sufficient compressive force, one of the most important issues is the contact resistance between MEA 126 and the current collectors 118a,b. The current collector 118a,b may be selected from a sheet of expanded metal mesh, metal wire mesh, perforated metal or other electrically conductive sheet with a large portion of open area to increase the gas/liquid flow to and from the catalyst areas. A sheet of expanded metal mesh is preferable in the present application.

Expanded metal mesh sheets are available from a variety of manufacturers, in a wide range of thickness and manufactured from a variety of metals, including titanium, nickel, copper, stainless steel, aluminum, and niobium. They are available in configurations having total open areas ranging from about 10% to about 70% of the surface area. A typical expanded metal sheet has two primary directions. For best performance, the expanded metal sheet is preferably oriented in such a way that the current flows in the longitudinally, that is, in the direction parallel to the “long way” of the diamond, since the electrical resistance is lowest in this direction.

Perforated metal sheets are also suitable as the conductive component. Compared to expanded metal, perforated metal sheets are generally stronger and more conductive, but they generally have a smaller percentage of open areas (<40%), and are thus less conductive to gas/liquid transfer therethrough.

Woven metal wire meshes are suitable as well. Compared to expanded metal, woven meshes have a greater percentage of open area (up to about 80%) for superior gas/liquid transfer. However, the woven metal meshes generally have a higher electrical resistance, primarily because it is necessary for the current to flow through a large number of wire-to-wire contacts. Furthermore, because of the woven nature of the material, any individual sheet can be only as thin as twice the wire diameter.

Since the metal grid is quite close to membrane 112, it is imperative that the metal does not corrode. Corrosion will not only increase the contact resistance between the active portion of the electrode, that is, anode or cathode 114 and 116, and respective adjacent current collector 118a,b, but it will provide mobile metal ions that, if they come into contact with membrane 112, may replace protons in the membrane. Replacing even a small fraction of the protons in the membrane with far less mobile metal ions leads to a significant drop in membrane conductivity. The best way to impart these properties to a piece of lightweight material is to plate the metal with a layer of a more precious metal, such as platinum, to protect from corrosion and to improve electrical contacts.

Platinum is typically used on the surface as a primary current collector material due to its excellent corrosion resistance under DMFC working conditions coupled with its ability to pass current without forming an insulating film. A major disadvantage associated with platinum is its high cost, thus it is most desirable to use as little platinum as necessary. In order to restrict the amount of platinum used and to maintain a current collector of some structural integrity, it is necessary to use some type of substrate material.

It is important that the substrate has the ability to form an insulating film under fuel cell working conditions, such that a dimensionally stable current collector is obtained, along with good conductivity, and at relatively low cost. Because there are no individual materials that fully meet all of these criteria, it is necessary in most cases to use a combination of materials to form a layer having the desired characteristics.

Both niobium and titanium have the ability to form insulating oxide films under fuel cell conditions, and both possess unique advantages and disadvantages as a substrate for platinum. The major advantage of titanium is its low cost, particularly when considering its lower density. Unfortunately, there are many applications where the disadvantages of titanium far outweigh its cost advantage. For example, a major disadvantage of titanium is its poor electrical conductivity (23.81 l/mohm-cm), which is approximately 4 times less than the electrical conductivity of niobium and 25 times less than that of copper. The use of niobium as a substrate with platinum eliminates many of the problems associated with titanium. The principal disadvantage of niobium, however, is its relatively high cost. Overall, the combination of high conductivity and low cost allows copper to be an ideal candidate for use in the design of a current collector material.

In reviewing the properties of these materials, it becomes quite clear that a combination of these materials that exploits only the advantages would be a superior current collector material. The most logical combination of materials includes the use of a platinum outer layer, very thin due to cost, a layer of niobium beneath the platinum to allow for dimensional stability, and a copper expanded metal mesh core for both conductivity and economy. The niobium layer is preferably durable and resilient enough to withstand normal mechanical handling.

Forming the MEA

The anode and cathode catalytic, gas diffusion layers 128 and 132 are formed as an integral parts of either the ion conducting membrane 112 or the anode and cathode 114 and 116, respectively. In either case, electrode backing layers 130 and 134 are placed on each side of the ion conduction membrane 112, with catalyst layers 128 or 132 between each electrode backing layer 130 and 134 and ion conducting membrane 112 to form a five-layer MEA in accordance with the present invention. The electrode backing layers 130 and 134 and the ion conducting membrane 112 must be held closely together to reduce resistance to ionic/or electrical flow between the elements, since ionic resistance exists in the catalyst layers 128 and 132 and the electrolyte membrane 112. The elements can be held together by stack pressure, generally with two end plates (not shown) ultimately applying the pressure. Preferably, the elements are laminated together, a process that ensures physical proximity, as an alternative to using stack pressure. Lamination can be accomplished in a variety of ways: using heat, pressure or solvent. Heat lamination and solvent lamination also may involve the addition of some pressure. The appropriate methods for lamination depend on the materials.

As an example, proton exchange membrane 112 can be sandwiched between anode and cathode layers 114 and 116. The formation can be hot-pressed at about 125° C. with 1500 psi for about 5 minutes, thereby preparing a five-layer MEA 126 (preferably, if the materials include Teflon, it is allowed to split off after cooling down).

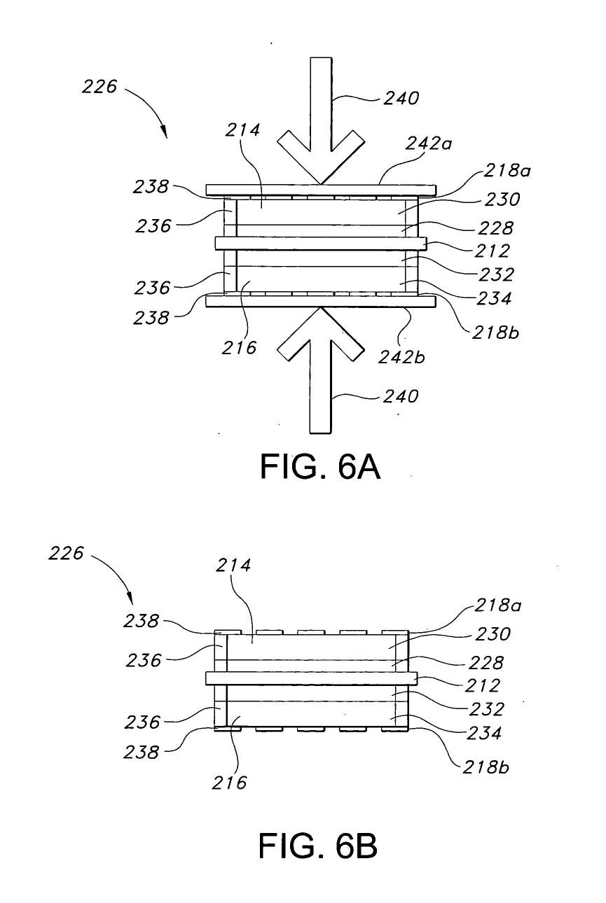

Because MEA delamination usually occurs at the edges first, increasing adhesion at the edges of the MEA of the present invention will greatly reduce the potential for delamination. It is preferable for the polymeric binder to be made of the same material as the membrane. In this embodiment, the preferred material is Nafion®. It is common practice to spray a coating of Nafion® at the interface of the anode and/or cathode backing and catalyst layers. Because Nafion® is electron non-conductive, this coating of Nafion® will increase the electrical resistance of a fuel cell. To solve this problem, a backing layer 230, as shown in FIG. 5A, preferably formed of carbon, is chosen having an area that is larger than that of the adjacent catalyst layer 228. The edge or perimeter 236 of backing layer 230 and the membrane 212 will be bonded for the purposes of enhancing binding. Area 236 of backing layer 230 is coated, impregnated or otherwise integrated with a Nafion® suspension (i.e., 10% Nafion® in a water aliphatic alcohol mixture).

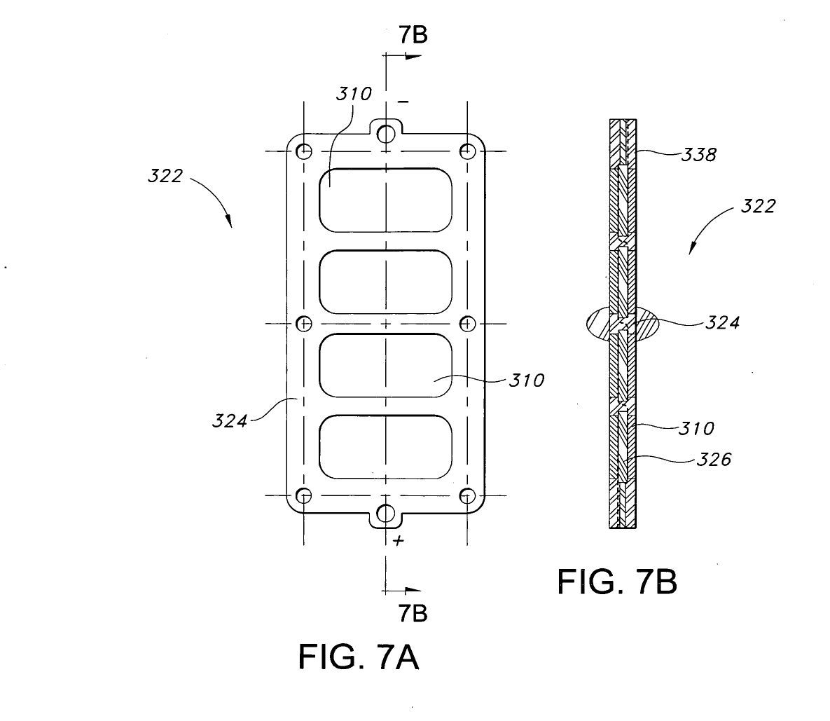

When the backing layer 230 and membrane 212 are hot-pressed together, coating along perimeter 236 enhances the bond between layer 230 and membrane 212. After curing at 130° C. for 5 minutes, this bond becomes strong enough to prevent delamination at the edges. To bond a U-shaped metal mesh current collector 218 as shown in FIG. 5B, to the opposing surface of backing layer 230, a similar procedure can be applied. The edges or perimeter 238 of current collector 218 are dipped in a solution of 10% Nafion® in a water aliphatic alcohol mixture for about 1 minute and subsequently air-dried. Current collector 218 is then hot-pressed with the backing layer 230 to form a seven-layer MEA 226 structure as shown in FIGS. 6A and 6B. The resulting seven-layer MEA is ready for assembly into a support structure 124 to form a planar fuel cell stack in accordance with the present invention.

MEA 226 includes a proton exchange membrane 212 in between anode 214 and cathode 216. Anode 214 includes anode catalyst layer 228 which is adjacent membrane 212 and an anode backing layer 230 which is disposed adjacent the opposing side of anode catalyst layer 228. Cathode 216 is preferably similarly arranged with a cathode catalyst layer 232 and cathode backing layer 234. Current collectors 218a,b are disposed on the outer ends of MEA 226, that is, current collector 218a is positioned adjacent anode backing layer 230 and current collector 218b is positioned adjacent cathode backing layer 234. Perimeter 236 of both backing layers 230 and 234 are coated with Nafion® and perimeter 238 of both current collectors 218a and 218b are also coated with Nafion® suspension.

MEA is hot pressed, as shown by arrows 240 in FIG. 6A, with outer Teflon layers 242a and 242b disposed adjacent the exposed sides of current collectors 218a, 218b, respectively. After cooling, Teflon layers 242a and 242b are removed.

Forming the Fuel Cell Stack

A piece of thermo-bond film (pre-cut to the configuration of a gasket) is placed between two fixture plates and hot pressed at about 135° C. and a pressure of about 10-20 psi for about 2-5 seconds. The thermo-bond film mentioned above can be Thermo-Bond Film 615 (available from 3M Electronics Adhesives and Specialties Department, Engineering Adhesives Division), or any other like material. The thermo-bond film also serves as a gasket.

It should be noted that to make a bond using Thermo-Bond Film 615, the adhesive film can be first tacked (lightly bonded) to the window frames using low heat (about 40° C., 1-2 seconds dwelling time, 350 g/cm²), then by removing the liner and placing the cells between two window frames, making the bond using heat and pressure.

Exemplary Planar Fuel Cell Stacks of the Present Invention

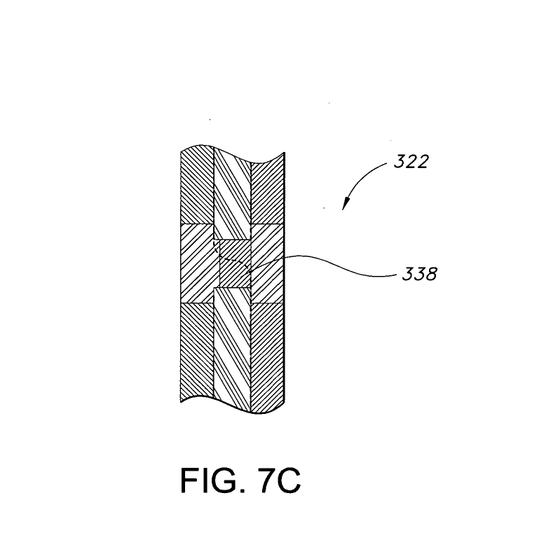

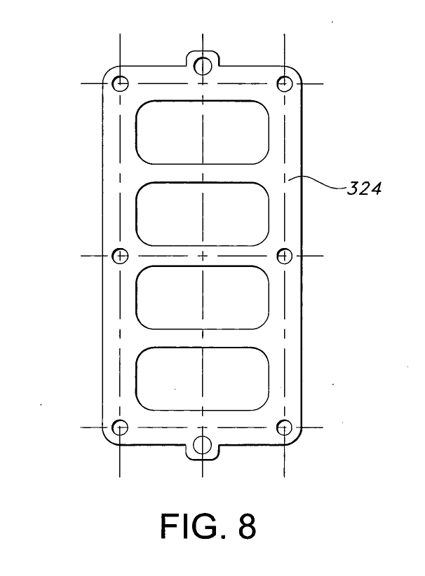

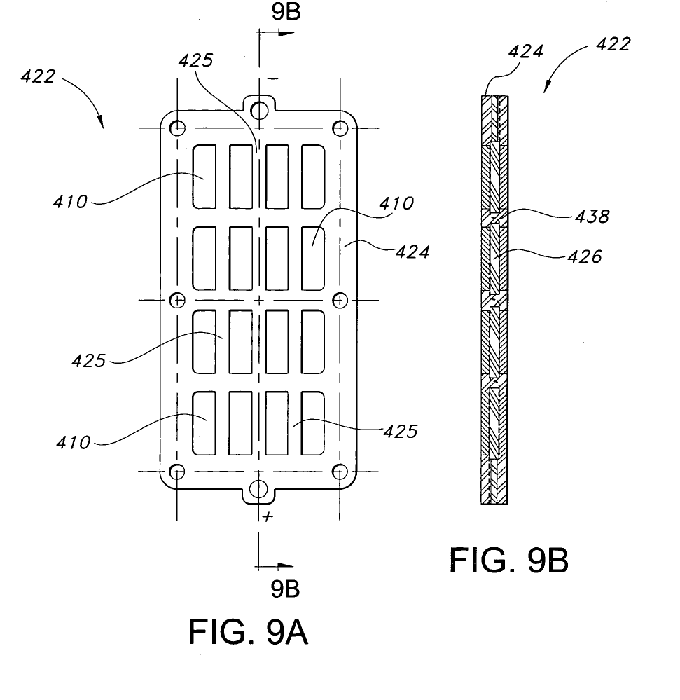

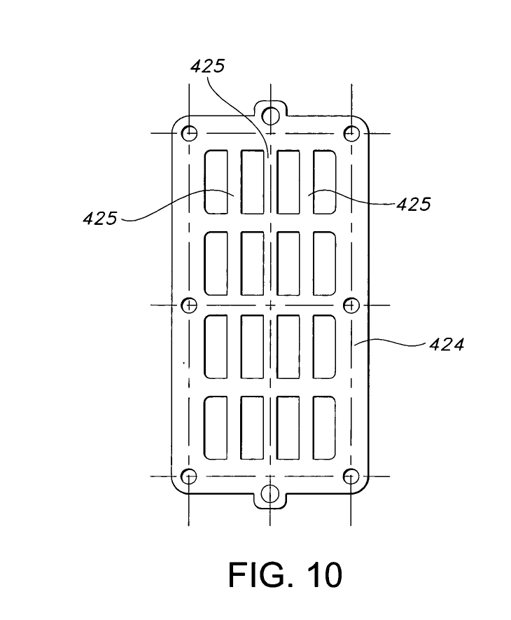

To achieve a greater and more useful potential, multiple single cells are connected in a series by a current collector sheet 338 disposed in the support structure 324 of the present invention. A planar fuel cell stack 322 consisting of multiple cells is shown in FIGS. 7A, 7B and 7C. Current collector sheet 338 used to electrically connect adjacent cells 310. The common current collector sheet 228 alternates positions at the anode side of the first cell and to the cathode side of the second cell. FIG. 8 illustrates the support structure 322 for the planar fuel cell stack shown in FIGS. 7A, 7B and 7C. FIGS. 9a and 9B and 10 illustrate another exemplary embodiment of the planar fuel cell of the present invention in which a planar fuel cell stack 422 includes four single cells 410 in a support structure 424 including three support ribs 425 for reinforcement purposes. Preferably, the current collectors 318a,b and 418a,b are a platinum plated metal mesh, as described above.

Having described embodiments of the present invention, various alterations, modifications, and improvements will be apparent to those of ordinary skill. Such alterations, modifications, and improvements are intended to be within the spirit and scope of the invention. The invention is not limited just to the foregoing disclosure of certain embodiments thereof.

1. An air breathing fuel cell comprising an air permeable cathode layer positioned to be in contact with atmospheric air and an electrically conductive, fuel permeable anode backing layer positioned to be in contact with a mixture of fuel and water, wherein the anode and cathode layers are divided by a pre-swollen electrolyte membrane, and the anode and cathode layers are in contact with electrical current collecting members.

2. The air breathing fuel cell according to claim 1, wherein the current collecting member is in the form of an electrically conductive mesh.

3. The air breathing fuel cell according to claim 2, wherein the mesh is configured and dimensioned so that the percentage of total open area along its surface ranges from about 10% to about 80% of the total surface area.

4. The air breathing fuel cell according to claim 2, wherein the mesh is fabricated of a substantially non-corrosive material.

5. The air breathing fuel cell according to claim 2, wherein the mesh is formed of a composite including a non-corrosive substantially rigid substrate and electrically conductive layer.

6. The air breathing fuel cell according to claim 2, wherein the mesh is formed of a substantially copper core, layer of substantially niobium disposed on the copper core and an outer layer substantially of platinum disposed on the substantially niobium layer.

7. The air breathing fuel cell according to claim 1, wherein the shape of the pre-swollen membrane defines a longitudinal x-axis, latitudinal y-axis and depth defined by a z-axis, and the membrane is formed by a pre-swelling method comprising the steps of:
a) exposing the membrane to an aqueous methanol solution;
b) securing the longitudinal and latitudinal edges of the membrane to prevent longitudinal and latitudinal shrinking while permitting the membrane to shrink along the z-axis; and
c) drying the secured membrane.

8. The air breathing fuel cell according to claim 7, wherein the aqueous methanol solution is a 10M methanol solution.

9. The air breathing fuel cell according to claim 7, wherein the secured membrane is allowed to air dry.

10. The air breathing fuel cell according to claim 7, further comprising the step of reducing the membrane into portions commensurate with size and shape of the single cell.

11. The air breathing fuel cell according to claim 1, wherein the anode backing layer is formed of a material which has been treated to impart hydrophilic characteristics thereon.

12. The air breathing fuel cell according to claim 11, wherein the anode backing layer has been treated by a method comprising the following steps:
a) dissolving tin tetrachloride pentahydrate (SnCl₄.5H₂O) in water to yield a concentration of tin tetrachloride of about 1.7 moles per liter;
b) pouring the tetrachloride solution into a vial to sufficient depth to amply submerge carbon fiber media placed therein;
c) placing the vial into a ultrasonic bath and apply ultrasonic treatment for about 10 minutes;
d) removing the carbon fiber medium from the tin tetrachloride solution in an aqueous solution of ammonia of concentration sufficient to achieve a pH of about 9;
e) maintaining the pH of the bulk of the solution in the range of about 5 to about 9 for a period of about 6 hours;
f) removing the carbon fiber paper from the ammonia solution; and
g) calcining the fiber paper in air at a temperature of about 400° C. for about one hour.

13. The air breathing fuel cell according to claim 12, wherein the method further comprises the step of repeating the process to improve the carbon fiber medium wettability.

14. The air breathing fuel cell according to claim 1, wherein the fuel cell is formed by being hot pressed along with thermo-bond film.

15. A fuel cell stack, wherein a plurality of fuel cells according to claim 1 are arranged in a grid-like planar formation within an support frame including electrically conductive portions for electrically connecting the plurality of the fuel cells.

16. A fuel cell stack according to claim 15, wherein the support frame is configured to provide electrical connections with the current collecting members.

17. A method of forming a planar fuel cell stack comprising the steps of:
a) pre-swelling an electrolyte membrane having a first and a second surface;
b) treating an electrically conductive anode backing layer having a first and a second surface to impart hydrophilic characteristics thereto;
c) providing an electrically conductive cathode backing layer having a first and a second surface;
d) disposing the first surface of the electrically conductive anode backing layer on the first surface of the electrolyte membrane and the second surface of the electrically conductive cathode backing layer on the second surface of the electrolyte membrane;
e) disposing a first current collecting member on the first surface of the cathode backing layer and a second current collecting member on the second surface of the anode backing layer; and
f) securing the entire configuration in position.

18. A method of forming a planar fuel cell stack according to claim 17, wherein the configuration is secured by hot-pressing.

19. A method of forming a planar fuel cell stack according to claim 17, further comprising the step of securing a plurality of fuel cells in a grid-like pattern on a support frame configured to provide electrical connections between the plurality of individual fuel cells.
